(19) United States
(12) Patent Application Publication
(10) Pub. No.: US 2015/0325831 A1
(43) Pub. Date: Nov. 12, 2015

(54) POLYIMIDE WEB SEPARATOR FOR USE IN AN ELECTROCHEMICAL CELL

(71) Applicant: E I DU PONT DE NEMOURS AND COMPANY, Wilmington, DE (US)

(72) Inventors: T. Joseph Dennes, Parkesburg, PA (US); Raymond Adam, Strassen (LU); Srijanani Bhaskar, Landenberg, PA (US); Noel Stephen Brabbs, Garnich (LU); David M. Groski, Hockessin, DE (US); Eric Huebsch, Contern (LU); Charles E. Jackson, JR., Middletown, DE (US); Stephen Mazur, Wilmington, DE (US); Peiwen Zheng, Wilmington, DE (US)

(21) Appl. No.: 14/705,782

(22) Filed: May 6, 2015

Related U.S. Application Data
(60) Provisional application No. 61/989,576, filed on May 7, 2014.
(60) Provisional application No. 61/989,580, filed on May 7, 2014.
(60) Provisional application No. 61/989,586, filed on May 7, 2014.

(51) Int. Cl. H01M 2/16; H01G 11/06; H01G 11/58; H01G 11/52; H01G 11/28; H01M 10/052; H01G 11/56

(52) U.S. Cl. CPC H01M 2/1686; H01M 2/162; H01M 2/1666; H01M 2/1673; H01M 10/052; H01G 11/06; H01G 11/56; H01G 11/52; H01G 11/28; H01G 11/58

(57) ABSTRACT

The present invention is directed to a separator for an electrochemical cell comprising a web, the web comprising fibers of a polyimide and a protective region wherein the protective region impedes electrochemical reduction of the polyimide inside the electrochemical cell. The present invention is further directed to a multi-layer article and electrochemical cell containing the separator.

### CROSS-REFERENCE TO RELATED APPLICATIONS

This invention claims the benefit of priority of U.S. Provisional Application Nos. 61/989,576, 61/989,580 and 61/989,586 all filed on May 7, 2014, the entirety of which are herein incorporated by reference.

### FIELD OF THE INVENTION

The present invention relates to separators for electrochemical cells, multilayer articles comprising separators for electrochemical cells, and electrochemical cells comprising separators.

### BACKGROUND OF THE INVENTION

Commercially available electrochemical cells typically employ microporous membranes based on polyethylene and/or polypropylene as a battery separator. These membranes begin to shrink at >90° C., limiting the battery fabrication process, the operating temperature and power available from the battery.

Polyimide nonwovens are one of many candidates that are being explored for use as polymeric separators for electrochemical cells. Polyimides have long been valued in the market place for their combination of strength, chemical inertness in a wide variety of environments, and thermal stability.

The requirements for choosing an improved polymeric separator for high energy density electrochemical devices are complex. A suitable separator combines good electrochemical properties, such as high electrochemical stability, low charge/discharge/recharge hysteresis, good shelf life, low first cycle irreversible capacity loss and the like, with good physical properties, such as tensile strength, wettability by the electrolyte, and high temperature melt integrity.

Shelf-life of an electrochemical cell is related to capacity loss during storage of the electrochemical cell and the properties of a separator are often optimized to minimize its contribution to this capacity loss. Irreversible capacity loss can occur due to inherent chemical instability of the electrolyte or electrodes, or due to reactions between electrolyte and electrodes with contaminants such as water. Likewise, the separator must be inert to irreversible chemical or electrochemical reaction with electrodes and electrolyte to avoid any charge leakage through the separator. Hence, there is a need for separator materials which minimally contribute to any unproductive reversible electrochemical processes in an electrochemical cell.

Schwartz et al., U.S. Published Patent Application No. 20110110986, disclose methods of modifying polymer surfaces with organometallic compounds, wherein the organometallic compounds contains transition metal atoms selected from atoms of Group 4-6 of the Periodic Chart.

Gogotsi et al., WO No. 2010028017, disclose method for electrospraying nanosized metal or metal oxide particles onto a substrate.

### SUMMARY OF THE INVENTION

The present invention is directed toward a separator for an electrochemical cell, the separator comprising: (a) a web comprising fibers of a polyimide; and (b) a protective region wherein the protective region impedes electrochemical polyimide reduction. The electrochemical cell can be a battery or a capacitor. The battery can be lithium ion battery, lithium metal primary battery or other types of batteries (NiCD, NiMH, alkaline).

In another embodiment, the present invention is directed toward a multi-layer article for an electrochemical cell, the multi-layer article comprising: (a) a first electrode; (b) a second electrode; and (c) a separator disposed between and in contact with the first electrode and the second electrode, the separator comprising: (i) a web comprising fibers of a polyimide; and (ii) a protective region disposed between the web and at least one electrode wherein the protective region impedes electrochemical polyimide reduction.

In still another embodiment, the present invention is directed toward an electrochemical cell comprising: (a) an electrolyte; (b) a multi-layer article, the multi-layer article comprising a first electrode, a second electrode in ionically conductive contact with the first electrode, and a separator disposed between and in contact with the first electrode and the second electrode, the separator comprising: (i) a web comprising fibers of a polyimide; and (ii) a protective region disposed between the web and at least one electrode wherein the protective region impedes electrochemical polyimide reduction; (c) a first current collector in electrically conductive contact with the first electrode; and (d) a second current collector in electrically conductive contact with the second electrode.

### BRIEF DESCRIPTION OF THE DRAWINGS

FIG. 1 schematically illustrates a cross-sectional view of a portion of a multi-layer article, in accordance with various embodiments of the present invention.

FIG. 1A schematically illustrates a blown up view of a separator of the multi-layer article shown in the FIG. 1.

FIG. 1B schematically illustrates a blown up view of a fiber of the separator shown in the FIG. 1A.

FIG. 2 shows a schematic illustration of a cross-sectional view of a portion of a multi-layer article, in accordance with various embodiments of the present invention.

FIG. 3 schematically illustrates a perspective view of a multi-layer article in the form of a prismatic stack, in accordance with various embodiments of the present invention.

FIG. 4 schematically illustrates a perspective view of a multi-layer article in the form of a spiral stack, in accordance with various embodiments of the present invention.

FIG. 5 schematically illustrates a cross-sectional view of an electrochemical cell, in accordance with various embodiments of the present invention.

FIG. 6 schematically illustrates a cross-sectional view of another embodiment of an electrochemical cell of the present invention.

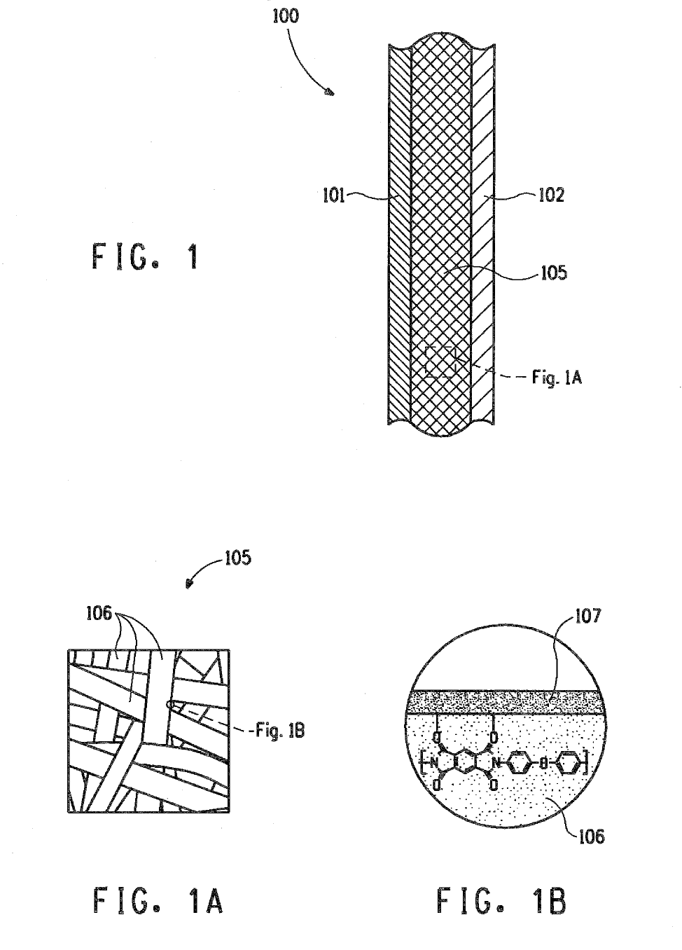

Reference numerals shown in FIGS. 1-6 are explained below:
100, 200, 500: multi-layer article
300: multi-layer article in the form of a prismatic stack
400: multi-layer article in the form of a spiral stack
550, 650: electrochemical cell
600a, 600b, 600c: individual cells in an electrochemical cell
101, 201, 301, 301′, 401, 401′, 501, 601, 601′: first electrode
102, 202, 302, 302′, 402, 402′, 502, 602, 602′: second electrode
105, 205, 305, 305′, 405, 405′, 505, 605, 605′: separator
106: nanofiber of polyimide
107: conformal coating disposed on at least a portion of the nanofiber, 106
311, 411, 511, 611, 611′: a first current collector
312, 412, 512, 612, 612′: a second current collector

### DETAILED DESCRIPTION OF THE INVENTION

Disclosed is an electrochemical cell comprising: (a) an electrolyte; (b) a multi-layer article, the multi-layer article comprising a first electrode, a second electrode in ionically conductive contact with the first electrode, and a separator disposed between and in contact with the first electrode and the second electrode, the separator comprising: (i) a web comprising fibers of a polyimide; and (ii) a protective region disposed between the web and at least one electrode wherein the protective region impedes electrochemical polyimide reduction; (c) a first current collector in electrically conductive contact with the first electrode; and (d) a second current collector in electrically conductive contact with the second electrode.

As used herein, the term “web” refers to a network of fibers. The fibers can be bonded to each other, or can be unbonded and entangled to impart strength and integrity to the web. The fibers can be oriented or randomly distributed with no overall repeating structure discernible in the arrangement of fibers. The fibers can be staple fibers or continuous fibers, and can comprise a single material or a multitude of materials, either as a combination of different fibers or as a combination of similar fibers each comprising of different materials.

As used herein, the term “nanoweb” refers to a nonwoven web constructed predominantly of nanofibers. “Predominantly” means that greater than 50% by number, of the fibers in the web are nanofibers, where the term “nanofibers” as used herein refers to fibers having a number average diameter of less than 1000 nm, even less than 800 nm, even between 50 nm and 800 nm, and even between 100 nm and 400 nm. In the case of non-round cross-sectional nanofibers, the term “diameter” as used herein refers to the greatest cross-sectional dimension. The nanoweb of the present invention can have greater than 70%, or 90%, or it can even contain 100% of nanofibers.

As used herein, the term “polyimide nanoweb” refers to a nanoweb comprising nanofibers of a polyimide.

For the purposes of the present invention, a suitable polyimide nanoweb is characterized by a porosity in the range of 20-95% or 30-60%, as determined by measured basis weight and thickness in ASTM D3776 and D1777, respectively.

In one embodiment of the separator, the polyimide is a fully aromatic polyimide.

Polyimides are typically referred to by the names of the condensation reactants (one or more aromatic dianhydride and one or more aromatic diamine) that form the monomer unit. That practice will be followed herein. Thus, the polyimide formed from the monomer units: pyromellitic dianhydride (PMDA) and oxy-dianiline (ODA) and represented by the structure below is designated PMDA/ODA.

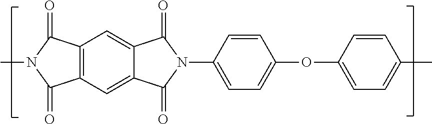

Suitable aromatic dianhydrides include but are not limited to pyromellitic dianhydride (PMDA), biphenyltetracarboxylic dianhydride (BPDA), and mixtures thereof. Suitable diamines include but are not limited to oxydianiline (ODA), 1,3-bis(4-aminophenoxy)benzene (RODA), and mixtures thereof. In a further embodiment, the fully aromatic polyimide is PMDA/ODA.

In an embodiment, the nanofibers of polyimide of this invention comprise more than 80 wt % of one or more fully aromatic polyimides, more than 90 wt % of one or more fully aromatic polyimides, more than 95 weight % of one or more fully aromatic polyimides, more than 99 wt % of one or more fully aromatic polyimides, more than 99.9 wt % of one or more fully aromatic polyimides, or 100 wt % of one or more fully aromatic polyimides. As used herein, the term “fully aromatic polyimide” refers specifically to polyimides in which at least 95% of the linkages between adjacent phenyl rings in the polymer backbone are affected either by a covalent bond or an ether linkage. Up to 25%, preferably up to 20%, most preferably up to 10%, of the linkages can be affected by aliphatic carbon, sulfide, sulfone, phosphide, or phosphone functionalities or a combination thereof. Up to 5% of the aromatic rings making up the polymer backbone can have ring substituents of aliphatic carbon, sulfide, sulfone, phosphide, or phosphone. Preferably, the fully aromatic polyimide suitable for use in the present contains no aliphatic carbon, sulfide, sulfone, phosphide, or phosphone.

In some embodiments, the nanofibers may comprise 0.1-10 wt % of non fully-aromatic polyimides such as P84® polyimide available from Evonik Industries (Lenzing, Austria); non fully-aromatic polymers from diaminodiphenyl methane as monomer; and/or other polymeric components such as polyolefins. P84® polyimide is a condensation polymer of 2,4-diisocyanato-1-methylbenzene and 1-1′-methylenebis[4-isocyanatobenzene] with 5-5′carbonylbis[1,3-isobenzofurandione], having the following structure:

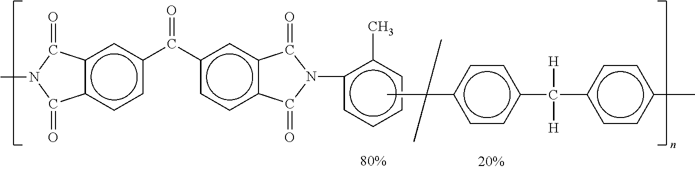

Aromatic polyimide nanowebs provide many benefits when used as separators for electrochemical cells including, but not limited to, high-temperature stability and a suitable critical surface tension due to polymer surface energy and nonwoven morphology, which enables wetting with organic electrolyte solutions such as LiPF₆ in ethylene carbonate/ethyl methyl carbonate.

In an embodiment, the polyimide becomes partially reduced upon contact with the graphite anode in an electrochemical cell. This electrochemical reduction reaction could potentially contribute to capacity loss in the electrochemical cell via redox exchange reactions, as reported by Mazur et al in J. Electrochem Soc., 1987, 346. Thus, a protective region disposed between the web and the electrodes wherein the protective region impedes electrochemical polyimide reduction provides further advantage of reducing self-discharge capacity loss in an electrochemical cellan electrochemical cell.

As used herein, the term “protective region” refers to an electrochemically inert area that surrounds or covers the fibers without completely occluding the pores of the nanoweb.

In an embodiment, the protective region comprises a coating on the fibers comprising particles of (a) oxides of silicon, aluminum, calcium, or mixtures thereof, ranging from about 1 to about 20,000 nm, from about 1 to about 10,000 nm, or from about 1 to about 4,000 nm in diameter, and, optionally, a binder; (b) oxides of zirconium, tantalum, silicon, hafnium, or mixtures thereof; (c) silanes, (d) silsesquioxanes; (e) organic polymers characterized with a Hansen solubility parameter (δp) of at most about 19.2 MPa^{1/2} or at least about 23.2 MPa^{1/2}; or (f) mixtures thereof.

As used herein, the term ‘coating’ is defined as a material being present on at least a portion of the filament of the nanoweb.

As used herein, the term ‘conformal coating’ is defined as a coating that mimics the shape and surface of the filament of the nanoweb. As used herein, the term ‘non-conformal coating’ is defined as a coating that contains non-uniformities in mimicking the shape and surface of the filaments on a portion of the nanoweb.

In an embodiment, the protective region comprising a coating on the fibers has an average thickness in the range of one of: from about 0.1 to about 5000 nm, from about 1 to about 175 nm, or from about 2 to about 100 nm.

In an embodiment, the protective region comprising a coating on the fibers is a conformal coating or a non-conformal coating.

In one embodiment, the protective region impedes electrochemical polyimide reduction resulting in an efficiency of protection for at least one electrode from one of: at least about 10%, at least about 20%, or at least about 30%.

As used herein, the term “protection efficiency” is defined as:

η(%)=[1−(amount of electrochemically reduced polyimide in presence of protective region at the positive electrode/amount of electrochemically reduced polyimide in the absence of protective region at the positive electrode)]×100%

In an aspect of the invention, there is a multi-layer article for an electrochemical cell, the multilayer article comprising a first electrode, a second electrode, and a separator disposed between and in contact with the first electrode and the second electrode, the separator comprising a web, the web comprising fibers of a polyimide, and a protective region disposed between the web and at least one electrode wherein the protective region impedes electrochemical polyimide reduction.

In an embodiment, the protective region comprises a coating on the fibers comprising (a) particles of oxides of silicon, aluminum, calcium, or mixtures thereof, ranging from about 1 to about 20,000 nm, from about 1 to about 10,000 nm, or from about 1 to about 4,000 nm in diameter, and, optionally, a binder; (b) oxides of zirconium, tantalum, silicon, hafnium, or mixtures thereof; (c) silanes; (d) silsesquioxanes; (e) organic polymers characterized with a Hansen solubility parameter (δp) of at most about 19.2 MPa^{1/2} or at least about 23.2 MPa^{1/2}; or (f) mixtures thereof.

FIG. 1 schematically illustrates a cross-sectional view of a portion of a multi-layer article, 100 for an electrochemical cell, in accordance with an embodiment of the present invention. The multi-layer article, 100 comprises a first electrode, 101, a second electrode, 102, and a separator, 105, disposed between and in contact with the first electrode, 101 and the second electrode, 102. The separator, 105 comprises a nanoweb, as shown schematically in FIG. 1A, the nanoweb comprising nanofibers, 106 of a polyimide, and a protective region on the nanofibers 107 disposed on at least a portion of the nanofibers, 106, as shown schematically in FIG. 1B. In an embodiment, the protective region 107 comprises of a coating on the nanofibers comprising (a) particles of oxides of silicon, aluminum, calcium, or mixtures thereof, ranging from about 1 to about 20,000 nm, from about 1 to about 10,000 nm, or from about 1 to about 4,000 nm in diameter, and, optionally, a binder; (b) oxides of zirconium, tantalum, silicon, hafnium, or mixtures thereof; (c) silanes; (d) silsesquioxanes; (e) organic polymers characterized with a Hansen solubility parameter (δp) of at most about 19.2 MPa^{1/2} or at least about 23.2 MPa^{1/2}; or (f) mixtures thereof.

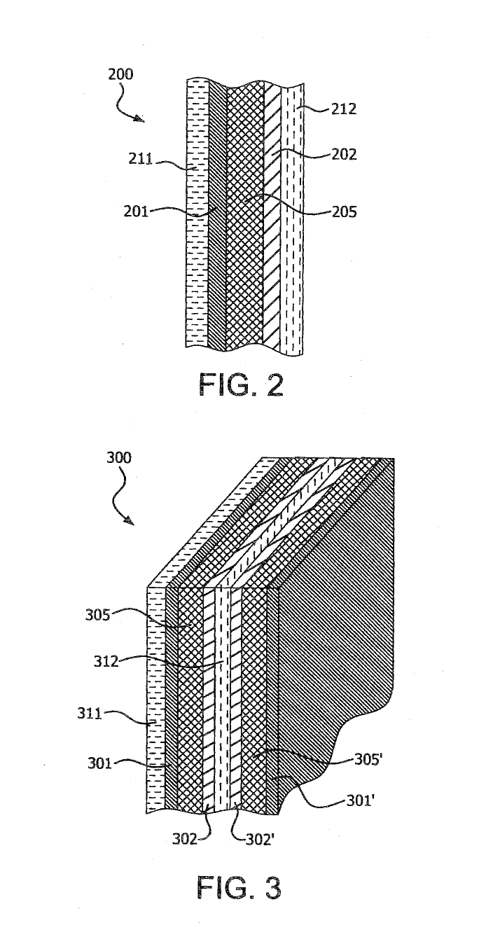

FIG. 2 schematically illustrates a cross-sectional view of a portion of another embodiment of a multi-layer article, 200 for an electrochemical cell. The multi-layer article, 200 comprises a first electrode, 201; a first current collector, 211 in electrically conductive contact with the first electrode, 201; a second electrode, 202; a second current collector, 212 in electrically conductive contact with the second electrode, 202, and a separator, 205 disposed between and in contact with the first electrode, 201 and the second electrode, 202. The separator, 205 comprises a web comprising nanofibers of a polyimide, and a protective region on at least a portion of the nanofibers.

In one embodiment of the multi-layer article, 100, 200, the nanofibers, 106, as shown in FIG. 1A, are characterized by a number average diameter of less than 1000 nm. In an embodiment, the nanofibers, 106 are characterized by a number average diameter in the range of 50-800 nm. In a further embodiment, the nanofibers, 106 are characterized by a number average diameter in the range of 100-400 nm.

In one embodiment of the multi-layer article, 100, 200, the polyimide is a fully aromatic polyimide. In a further embodiment, the fully aromatic polyimide is PMDA/ODA.

In an embodiment, the fully aromatic polyimide comprises at least one aromatic dianhydride as a monomer unit selected from the group consisting of, biphenyltetracarboxylic dianhydride (BPDA), and 3,3′,4,4′-benzophenone tetracarboxylic dianhydride (BTDA), and mixtures thereof; and at least one diamine as a monomeric unit selected from the group consisting of 1,3-bis(4-aminophenoxy)benzene (RODA), 1,4-phenelenediamine (PDA), and mixtures thereof.

In an embodiment, the first electrode, 101, 201 and the second electrode, 102, 202 have different material composition, and the multi-layer article 100, 200 hereof is useful as a lithium-ion battery. In an alternative embodiment, the first electrode, 101, 201 and the second electrode, 102, 202 have the same material composition, and the multi-layer article 100, 200 hereof is useful in capacitors, particularly in that class of capacitors known as “electronic double layer capacitors”, such as lithium-ion capacitors.

In one embodiment the first electrode, 101, 201 comprises carbon, graphite, coke, lithium titanates, lithium-tin alloys, silicon, carbon-silicon composites, or mixtures thereof. In a further embodiment, the second electrode, 102, 202 comprises lithium cobalt oxide, lithium iron phosphate, lithium nickel oxide, lithium manganese phosphate, lithium cobalt phosphate, lithium cobalt aluminum oxide, lithium manganese oxide, lithium nickel cobalt manganese oxide, lithium nickel aluminum oxide, or mixtures thereof.

In one embodiment, the first electrode, 101, 201; the separator, 105, 205; and the second electrode, 102, 202 are in mutually adhering contact in the form of a laminate. In another embodiment, each electrode material is combined with one or more polymers and other additives to form a paste that is applied to a surface of the nanoweb separator, 105, 205 having two opposing surfaces. Pressure and/or heat can be applied to form an adhering laminate.

In a further embodiment of the multi-layer article 200, at least one of the electrodes is coated onto a non-porous metallic sheet that serves as a current collector. In a preferred embodiment, both electrodes are so coated. In the battery embodiments of the electrochemical cell hereof, the metallic current collectors comprise different metals. In the capacitor embodiments of the electrochemical cell hereof, the metallic current collectors comprise the same metal. The metallic current collectors suitable for use in the present invention are preferably metal foils.

In one embodiment wherein the multi-layer article 200 is useful in lithium-ion batteries, the first electrode, 201, is a negative electrode material comprising graphite, an intercalating material for Li ions; the second electrode, 202 is a positive electrode material comprising lithium cobalt oxide; the separator 205 comprising a web, the web comprising fibers of fully aromatic polyimide, PMDA/ODA, and protective region comprising a coating on the fibers comprising of (a) particles of oxides of silicon, aluminum, calcium, or mixtures thereof, ranging from about 1 to about 20,000 nm, from about 1 to about 10,000 nm, or from about 1 to about 4,000 nm in diameter, and, optionally, a binder; (b) oxides of zirconium, tantalum, silicon, hafnium, or mixtures thereof; (c) silanes; (d) silsesquioxanes; (e) organic polymers characterized with a Hansen solubility parameter (δp) of at most about 19.2 MPa^{1/2} or at least about 23.2 MPa^{1/2}; or (f) mixtures thereof.

In a further embodiment, the multi-layer article, 200 comprises a first current collector, 211 comprising a copper foil in electrically conductive contact with the first electrode, 201; and a second current collector, 212 comprising an aluminum foil in electrically conductive contact with the second electrode, 201.

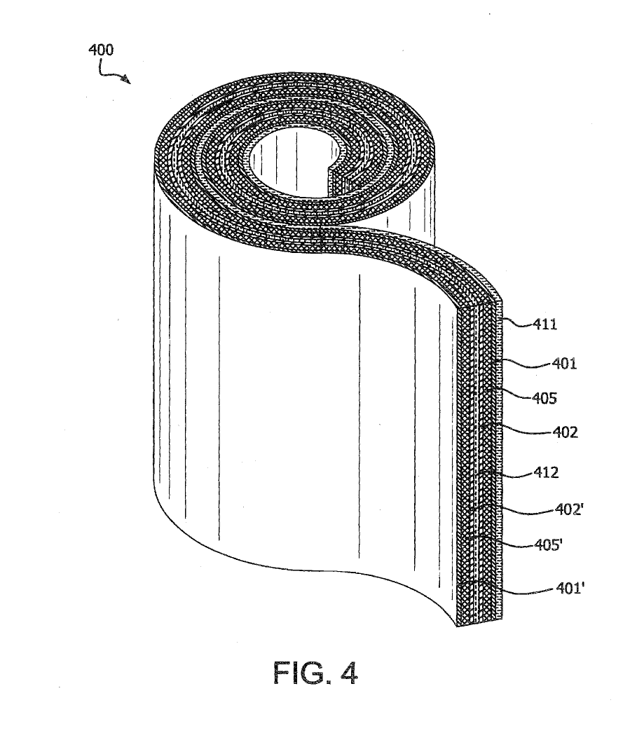

FIG. 3 schematic illustrates a perspective view of another embodiment of a multi-layer article, 300 of the present invention in the form of a prismatic stack. FIG. 4 schematic illustrates a perspective view of another embodiment of a multi-layer article, 400 of the present invention in the form of a spiral stack. The multi-layer article, 300, 400 comprise a first layer, 311, 411 comprising a first negative current collector; a second layer, 301, 401 comprising a first negative electrode in electrically conductive contact with the first layer, 311, 411; a third layer, 305, 405 comprising a first separator; a fourth layer, 302, 402 comprising a first positive electrode in contact with the third layer; a fifth layer, 312, 412 comprising a first positive current collector in electrically conductive contact with the fourth layer, 302, 402; a sixth layer, 302′, 402′ comprising a second positive electrode in electrically conductive contact with the fifth layer, 312, 412; a seventh layer, 305′, 405′ comprising a second separator in contact with the sixth layer, 302′, 402′; an eighth layer, 301′, 401′ comprising a second negative electrode in contact with the seventh layer, 305′, 405′. In an embodiment, one or more layers from the first layer to the eighth layer can be repeated. In a further embodiment, a last layer of the prismatic stack or the spiral stack of the multi-layer article 300, 400 comprises a positive current collector.

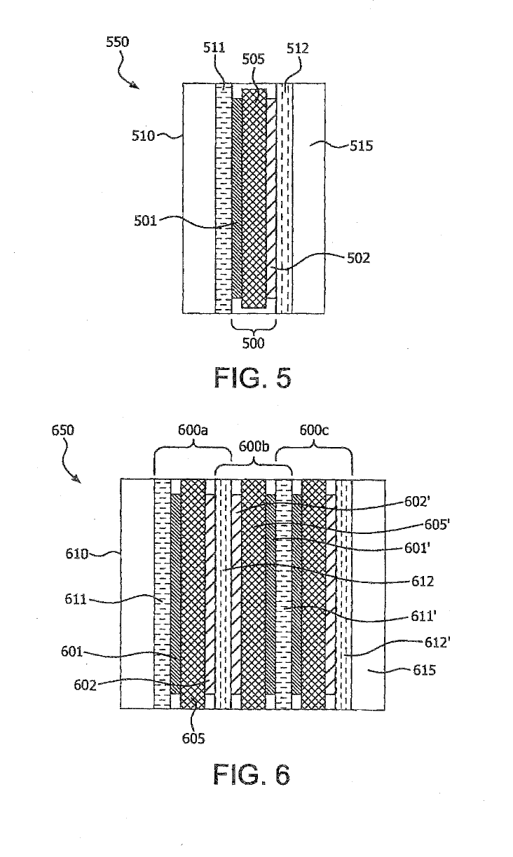

FIG. 5 schematically illustrates a cross-sectional view of an embodiment of an electrochemical cell, 550. The electrochemical cell, 550 comprises a housing, 510 having disposed therewithin, an electrolyte, 515, and a multi-layer article 500 at least partially immersed in the electrolyte, 515. The multi-layer article, 500 comprising a first electrode, 501, a second electrode, 502, and a separator, 505 as disclosed hereinabove, disposed between and in contact with the first electrode, 501 and the second electrode, 502 and wherein the first electrode, 501 and the second electrode, 502 are in ionically conductive contact with the electrolyte, 515. The electrochemical cell, 550 also comprises a first current collector, 511 in electrically conductive contact with the first electrode, 501 and a second current collector, 512 in electrically conductive contact with the second electrode, 502.

In one embodiment of the electrochemical cell, 550, the first current collector, 511 comprises a copper foil; the first electrode, 501 comprising graphite is in adhering contact with the copper foil; the separator 505 as disclosed hereinabove, comprising a nanoweb, the nanoweb comprising nanofibers of fully aromatic polyimide, PMDA/ODA, and protective region comprising a coating on the nanofibers disposed on at least a portion of the fibers; the second electrode, 502 comprising lithium cobalt oxide is in adhering contact with the nanoweb of the separator, 505; and the second current collector, 512 comprising an aluminum foil is in adhering contact with lithium cobalt oxide.

In a further embodiment, the electrolyte, 515 is a liquid electrolyte comprising an organic solvent and a lithium salt soluble therein. In a further embodiment, the lithium salt is LiPF₆, LiBF₄, or LiCIO₄. In a still further embodiment, the organic solvent comprises one or more alkyl carbonates. In a further embodiment, the one or more alkyl carbonates comprises a mixture of ethylene carbonate and dimethylcarbonate. The optimum range of salt and solvent concentrations may vary according to specific materials being employed, and the anticipated conditions of use; for example, according to the intended operating temperature. In one embodiment, the solvent is 70 parts by volume ethylene carbonate and 30 parts by volume dimethyl carbonate and the salt is LiPF₆.

Alternatively, the electrolyte, 515 may comprise a lithium salt such as, lithium hexafluoroarsenate, lithium bis-trifluoromethyl sulfonamide, lithium bis(oxalate)boronate, lithium difluorooxalatoboronate, or the Li⁺ salt of polyfluorinated cluster anions, or combinations of these. Alternatively, the electrolyte, 515 may comprise a solvent, such as, propylene carbonate, esters, ethers, or trimethylsilane derivatives of ethylene glycol or poly(ethylene glycols) or combinations of these. Additionally, the electroyte, 515 may contain various additives known to enhance the performance or stability of Li-ion batteries, as reviewed for example by K. Xu in Chem. Rev., 104, 4303 (2004), and S. S. Zhang in J. Power Sources, 162, 1379 (2006).

In another embodiment, the protective region comprises an additive to the electrolyte that reacts with and stabilizes the reduced polyimide to impede polyimide reduction. Suitable examples of additives include but are not limited to 1,3-propane sultone, ethylene oxide, and mixtures thereof.

Also present in the electrochemical cell, 550, but not shown, would be a means for connecting the cell to an outside electrical load or charging means. Suitable means include wires, tabs, connectors, plugs, clamps, and any other such means commonly used for making electrical connections.

FIG. 6 schematically illustrates a cross-sectional view of another embodiment of an electrochemical cell, 650 of the present invention. The electrochemical cell 650 comprises a stack of three multi-layer articles, 600a, 600b, 600c and an electrolyte, 615 disposed in housing, 610. In particular, the electrochemical cell 650 comprises a first negative current collector, 611; a first negative electrode, 601 in electrically conductive contact with the first negative current collector, 611; a first separator, 605 of the present invention; a first positive electrode, 602 in contact with the first separator, 605, wherein the first positive electrode, 602 is in ionically conductive contact with the first negative electrode, 601; a first positive current collector, 612 in electrically conductive contact with the first positive electrode, 602; a second positive electrode, 602′ in electrically conductive contact with the first positive current collector, 612; a second separator, 605′ comprising of the present invention, in contact with the second positive electrode 602′; a second negative electrode, 601′ in contact with the second separator, 605′, wherein the second negative electrode, 601′ is in ionically conductive contact with the second positive electrode, 602′; and so on, repeating one or more layers from the first negative current collector, 611, such that a last layer, 612′ comprises a positive current collector.

When the individual cells, 600a, 600b, 600c in the multi-layer stack, 600 are electrically connected to one another in series, positive to negative, the output voltage from the stack is equal to the combined voltage from each cell. When the individual cells, 600a, 600b, 600c making up the multi-layer stack, 600 are electrically connected in parallel, the output voltage from the stack is equal to the voltage of one cell. The average practitioner of the electrical art will know when a series arrangement is appropriate, and when a parallel.

The positive and negative electrodes in lithium-ion cells suitable for use in one embodiment of the present invention are similar in form to one another and are made by similar processes on similar or identical equipment. In one embodiment, active material is coated onto both sides of a metallic foil, preferably Al foil or Cu foil, which acts as current collector, conducting the current in and out of the cell. In one embodiment, the negative electrode is made by coating graphitic carbon on copper foil. In one embodiment, the positive electrode is made by coating a lithium metal oxide (e.g. LiCoO₂) on Al foil. In a further embodiment, the thus coated foils are wound on large reels and are dried at a temperature in the range of 100-150° C. before bringing them inside a dry room for cell fabrication.

The electrode thickness achieved after drying is typically in the range of 50-150 micrometers. In an embodiment, the one-side coated foil is fed back into the coating machine with the uncoated side disposed to receive the slurry deposition to produce a coating on both sides of the foil. In one embodiment, following coating on both sides, the electrodes so formed are then calendered and optionally slit to narrow strips for different size batteries. Any burrs on the edges of the foil strips could give rise to internal short circuits in the cells so the slitting machine must be very precisely manufactured and maintained.

Lithium-ion batteries are available in a variety of forms including cylindrical, prismatic, pouch, wound, and laminated. Lithium-ion batteries find use in a variety of different applications (e.g. consumer electronics, power tools, and hybrid electric vehicles). The manufacturing process for lithium-ion batteries is similar to that of other batteries such as NiCd and NiMH, but is more sensitive because of the reactivity of the materials used in lithium-ion batteries.

In an embodiment, the electrochemical cell, 550, 650 comprises the multi-layer article, 500, 600 in the form of a prismatic stack, for example, multi-layer article, 300 in prismatic form, as shown in the FIG. 3. In another embodiment, the electrochemical cell, 550, 650 comprises the multi-layer article, 500, 600 in the form of a spiral stack, for example, multi-layer article, 400 in spiral form, as shown in the FIG. 4.

To form the cylindrical embodiment of a Li-ion cell of the present invention, the electrode assembly is first wound into a spiral structure as depicted in the FIG. 4. Then, a tab is applied to the edge of the electrode to connect the electrode to its corresponding terminal. In the case of high power cells it is desirable to employ multiple tabs welded along the edges of the electrode strip to carry the high currents. The tabs are then welded to the can and the spirally wound electrode assembly is inserted into a cylindrical housing. The housing is then sealed but leaving an opening for injecting the electrolyte into the housing. The cells are then filled with electrolyte and then sealed. The electrolyte is usually a mixture of salt (LiPF₆) and carbonate based solvents.

Cell assembly is preferably carried out in a “dry room” since the electrolyte reacts with water. Moisture can lead to hydrolysis of LiPF₆ forming HF, which can degrade the electrodes and adversely affect the cell performance.

After the cell is assembled it is formed (conditioned) by going through at least one precisely controlled charge/discharge cycle to activate the working materials. For most lithium-ion chemistries, this involves creating the SEI (solid electrolyte interface) layer on the negative (carbon) electrode. This is a passivating layer which is essential to protect the lithiated carbon from further reaction with the electrolyte.

In another aspect, the invention provides an electrochemical double layer capacitor (EDLC). EDLCs are energy storage devices having a capacitance that can be as high as several Farads. Charge storage in double layer electrochemical capacitors is a surface phenomenon that occurs at the interface between the electrodes, typically carbon, and the electrolyte. In the double layer capacitor hereof, the conformally-coated polyimide nanoweb hereof serves as a separator that absorbs and retains the electrolyte thereby maintaining close contact between the electrolyte and the electrodes. The role of the polyimide web hereof as the separator is to electrically insulate the positive electrode from the negative electrode and to facilitate the transfer of ions in the electrolyte, during charging and discharging. Electrochemical double layer capacitors are typically made in a cylindrically wound design in which the two carbon electrodes and separators are wound together, the polyimide separators having high strength avoid short circuits between the two electrodes.

In an embodiment, there is a method of mitigating electrochemical reduction of the polyimide web in an electrochemical cell comprising disposing a separator disclosed hereinabove of the present invention between and in contact with a first electrode and a second electrode. The disclosed separator of the present invention comprises a web comprising nanofibers of a polyimide and a protective region comprising a coating on the web, wherein the protective region impedes electrochemical polyimide reduction.

In one embodiment, the separator comprising a nanoweb comprises nanofibers of a fully-aromatic polyimide. In a further embodiment, the fully-aromatic polyimide has the following formula:

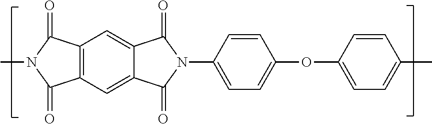

In an embodiment, the protective region comprises a coating of the fibers comprising particles of silicon, aluminum, calcium, or mixtures thereof, ranging from about 1 to about 20,000 nm, from about 1 to about 10,000 nm, or from about 1 to about 4,000 nm in diameter, and optionally a binder.

In another embodiment, the protective region comprises a coating of oxides of zirconium, tantalum, silicon, hafnium, or mixtures thereof. In another embodiment, the protective region comprises a coating of silanes.

In another embodiment, the protective region comprises a coating of silsesquioxanes. In another embodiment, the coating comprises organic polymers characterized with a Hansen solubility parameter (δp) of at most about 19.2 MPa^{1/2} or at least about 23.2 MPa^{1/2}; or mixtures thereof.

In one embodiment, the protective region impedes electrochemical polyimide reduction resulting in an efficiency of protection for at least one electrode from one of: at least about 10%, at least about 20%, or at least about 30% In an embodiment, the protective region comprises of a coating comprising of particles of inorganic oxides ranging from about 1 to about 20,000 nm, from about 1 to about 10,000 nm, or from about 1 nm to about 4,000 nm in diameter. Suitable oxides include of silicon, aluminum, calcium, titanium, or mixtures thereof.

In an embodiment, the protective region comprises of a coating comprising of a polymer with Hansen solubility parameter values lower than 19.2 MPa^{1/2}. Suitable polymers include but are not limited to polyethylene, polypropylene, polymethylpentene, poly(ethylene-co-vinyl acetate), polyisobutylene, poly(dimethylsiloxane), polyisoprene, poly(1,2-butadiene), polyvinyl alcohol, polyvinyl acetate, polyacrylic acid, polyacrylonitirile, and polyvinylidene fluoride or mixtures thereof.

In an embodiment, the protective region comprises of a coating comprising of polymer with Hansen solubility parameter values greater than 23.2 MPa^{1/2}. Suitable polymers include but are not limited to poly(cyanoethyl methacrylate), polyvinylpyrrolidone, poly(vinylidene chloride), poly(vinylidene fluoride), epoxy resins, cellulose and its derivates and poly(furfuryl alcohol).

In an embodiment, the coating comprises of amino resins. Suitable amino resins include partially or fully alkylated melamine formaldehyde resins, mixed ether melamine resins, alkylated high imino melamine formaldehyde resins, urea formaldehyde resins, partially or fully alkylated urea formaldehyde resins, benzoguanamine resins, glycoluril resins, phenol formaldehyde resins; functionalized amino resins, with solids content ranging from 0.1-90%, dispersed in solvents such as water, acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethyl ether, diethylene glycol, diglyme, dimethylether, dimethyl formamide, dimethyl sulfoxide, dioxane, ethanol, ethyl acetate, ethylene glycol, glycerin, heptane, hexamethylphosphoramide, hexane, methanol, methylene chloride, n-methyl-2-pyrrolidinone, pentane, petroleum ether, 1-propanol, 2-propanol, pyridine, tetrahydrofuran, toluene, triethyl amine, xylene, or mixtures thereof.

In an embodiment, the coating comprises of silanes and silsesquioxanes. Silanes that can form siliceous-like layer on polyimide web after coating and crosslinking impede electrochemical reduction of polyimide. Suitable silanes include, but are not limited to (3-aminopropyl) trimethyoxy silane, octadecyltrimethoxy silane and other alkyl tri-, bi-alkoxy-silanes, and mixtures thereof, and oligomeric silsesquioxane copolymers. As coupling agents, di-functional silanes have organic functional groups (e.g. amine groups) that can form hydrogen bonding with carbonyl on polyimide webs to provide better adhesion and multi-inorganic alkoxy groups that can crosslink to form siliceous-like network to form a conformal coating. The crosslinked protective coating will impede electrochemical reduction of polyimide.

In accordance with the invention, there is also provided a process of preparing a polyimide web having a protective region comprising a coating on the nanofibers. In one embodiment, the process comprises preparing a coating solution by dissolving an organometallic compound in a non-aqueous solvent and contacting at least a portion of the nanofibers of a polyamic acid nanoweb with the coating solution to form a precursor-coated polyamic acid nanoweb. The process further comprises maintaining the coating solution-coated polyamic acid nanoweb at a temperature until a desired degree of conversion to an oxide-coated polyamic acid nanoweb has achieved. The process further comprises thermally converting the polyamic acid of the oxide-coated polyamic acid nanoweb to the polyimide to form a conformally-coated polyimide nanoweb.

In another embodiment, the process of preparing a polyimide web having a protective region comprising a coating on the fibers comprises thermally converting the polyamic acid nanoweb to a polyimide web described infra. The process further comprises preparing a coating solution by dissolving an organic polymer in a non-aqueous solvent described infra and contacting at least a portion of the nanofibers of the polyimide web with the coating solution to form a conformally-coated polyimide web.

In an embodiment, the step of preparing a coating solution comprises dissolving 0.01-20%, or 0.05-10%, or 0.1-5% by volume of an (a) organometallic compound, in a non-aqueous solvent, wherein the amount in % by volume is based on the total volume of the coating solution. The organometallic compound has the formula: M^{+a}Xₐ, wherein M^{+a} is a metallic cation, a represents the highest oxidation state of the metallic cation, and X is one or more of OR, Cl, and Br, wherein R is a hydrocarbyl group. By hydrocarbyl is meant a straight chain, branched or cyclic arrangement of carbon atoms connected by single, double, or triple carbon to carbon bonds and/or by ether linkages, and substituted accordingly with hydrogen atoms. Such hydrocarbyl groups may be aliphatic and/or aromatic. Examples of hydrocarbyl groups include methyl, ethyl, propyl, isopropyl, butyl, isobutyl, t-butyl, cyclopropyl, cyclobutyl, cyclopentyl, methylcyclopentyl, cyclohexyl, methylcyclohexyl, benzyl, phenyl, o-tolyl, m-tolyl, p-tolyl, xylyl, vinyl, allyl, butenyl, cyclohexenyl, cyclooctenyl, cyclooctadienyl, and butynyl. Examples of substituted hydrocarbyl groups include toluyl, chlorobenzyl, fluoroethyl, p-CH₃—S—C₆H₅, 2-methoxy-propyl, and (CH₃)₃SiCH₂.

In an embodiment, the organometallic compound having the formula: M^{+a}Xₐ comprises a metallic cation M^{+a} derived from at least one of zirconium, tantalum, silicon, or hafnium. Exemplary organometallic compounds include zirconium tetra(tert-butoxide), zirconium tetra(butoxide), zirconium tetra(ethoxide), tantalum penta(ethoxide), hafnium tetra(tert-butoxide), tetraethylorthosilicate, or mixtures thereof.

In an embodiment, the coating solution comprises a non-aqueous solvent, such that the solvent will form at least 0.01% or 0.05% or 0.1% solution by volume with the organometallic compound or the organic polymer. Furthermore, the non-aqueous solvent does not solvate or react with the polyamic acid and does not react (hydrolyze or form sol-gel) with the organometallic compound, aside from ligand exchange reaction. Suitable solvent for preparing the coating solution comprises at least one of acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethyl ether, diethylene glycol, diglyme, dimethylether, dimethyl formamide, dimethyl sulfoxide, dioxane, ethanol, ethyl acetate, ethylene glycol, glycerin, heptane, hexamethylphosphoramide, hexane, methanol, methylene chloride, n-methyl-2-pyrrolidinone, pentane, petroleum ether, 1-propanol, 2-propanol, pyridine, tetrahydrofuran, toluene, triethyl amine, xylene, or mixtures thereof.

In an embodiment, the protective region exists on the electrodes. Suitable electrode additives include Metal oxide precursors (Silicon, Zirconium, Tantalum and Hafnium), that can be coated on the anode and/or cathode to form a metal oxide coating. The metal oxide coating will provide a protective region for polyimide web to impede electrochemical reduction of polyimide.

In an embodiment, the step of contacting at least a portion of the nanofibers of a polyamic acid web or a polyimide web with the coating solution comprises contacting for an amount of time in the range of 1 s to 30 min, or 5 s to 10 min, or 30 s to 5 min, to form a conformally-coated polyamic acid nanoweb or a conformally-coated polyimide nanoweb. The at least a portion of the fibers of a polyamic acid web or polyimide web can be contacted with the coating solution in an inert environment or in air using any suitable techniques, such as, dip-coating, spray-coating, roll-coating, slot die coating, knife over roll coating, microgravure-coating, gravure-coating or plasma deposition. The inert environment, such as nitrogen prevents the hydrolysis of the organometallic compound prior to reacting with the polyamic acid nanoweb. In an embodiment, the polyamic acid nanoweb is dried before the step of contacting it with a coating solution. Any suitable method of drying can be used, for example, drying can be done in a nitrogen-purged vacuum oven at a temperature in the range of room temperature to 100° C. or 50-75° C.

In an embodiment, the plasma coating composition comprises aliphatic and aromatic acrylates. Suitable examples include but are not limited to stearyl acrylate, propoxylated neopentyl glycol diacrylate, tricyclodecane dimethanol diacrylate, isobornyl acrylate, ethoxylated trimethylolpropane acrylate and mixtures thereof.

In an embodiment, the protective region comprises a mean flow pore diameter of at least about 50 nm, and a bubble point diameter of at least about 200 nm. Lower pore sizes are further beneficial in preventing leakage currents and propagation of Lithium dendrites.

In an embodiment, the polyamic acid web is a woven or a nonwoven fabric comprising fibers of a polyamic acid.

In an embodiment, the polyamic acid web comprises nanofibers of a fully aromatic polyamic acid. The fibers employed in this invention may comprise and preferably consist essentially of, or alternatively consist only of, one or more fully aromatic polyamic acid. For example, the fibers employed in this invention may be prepared from more than 80 wt % of one or more fully aromatic polyamic acid, more than 90 wt % of one or more fully aromatic polyamic acid, more than 95 wt % of one or more fully aromatic polyamic acid, more than 99 wt % of one or more fully aromatic polyamic acid, more than 99.9 wt % of one or more fully aromatic polyamic acid, or 100 wt % of one or more fully aromatic polyamic acid. The term “fully aromatic polyamic acid (PAA) nanoweb” refers to a nanoweb comprising PAA nanofibers, wherein the PAA is prepared by the condensation polymerization of at least one aromatic carboxylic acid dianhydride and at least one aromatic diamine in an aprotic solvent at low to moderate temperatures. The mole ratio of aromatic carboxylic acid dianhydride and aromatic diamine is between 0.2 to 6, or 0.5 to 2.0 or 0.9 to 1.0.

Suitable aromatic dianhydrides include but are not limited to pyromellitic dianhydride (PMDA); biphenyltetracarboxylic dianhydride (BPDA); 3,3′,4,4′-benzophenone tetracarboxylic dianhydride (BTDA); and mixtures thereof. Suitable aromatic diamines include but are not limited to oxydianiline (ODA); 1,3-bis(4-aminophenoxy)benzene (RODA); 1,4 Phenylenediamine (PDA); and mixtures thereof.

Suitable fully aromatic polyamic acid (PAA) are described by the following structural formula:

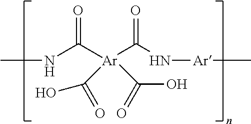

where n≧500, preferably ≧1000, Ar and Ar′ are each independently an aromatic radical formed from an aromatic compound including but not limited to benzene, naphthalene, biphenyl, diphenylamine, benzophenone, diphenyl alkenyl wherein the alkenyl comprises 1-3 carbons, diphenylsulfonone, diphenylsulfide, diphenylphosphone, diphenylphosphate, pyridine,

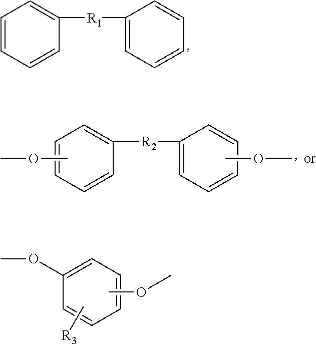

where R₁, R₂, and R₃ are independently an alkenyl radical having 1-3 carbons.

In one embodiment, the polyamic acid web consists essentially of polyamic acid nanofibers formed from pyromellitic dianhydride (PMDA) and oxy-dianiline (ODA), having repeat units represented by the structure shown below:

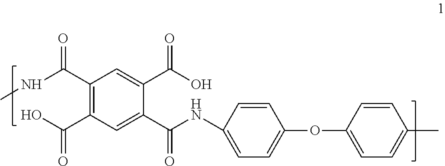

The polyamic acid is first prepared in solution; typical solvents are dimethylacetamide (DMAC) or dimethyformamide (DMF). Polyamic acid nanowebs suitable for the present invention can be fabricated by a process, such as, but not limited to, electroblowing, electrospinning, and melt blowing of a polyamic acid (PAA) solution. In one method suitable for the practice of the invention, the solution of polyamic acid is formed into a nanoweb by electroblowing, as described in Kim et al., U.S. Published Patent Application 2005/0067732. In an alternative method suitable for the practice of the invention, the solution of polyamic acid is formed into a nanoweb by electrospinning as described in Huang et al., Adv. Mat. DOI: 10.1002/adma.200501806.

As used herein, the terms “oxide-coated polyamic acid nanoweb” refers to a nanoweb comprising nanofibers of a polyamic acid, and a conformal coating of one or more of zirconium oxide, tantalum oxide, silicon oxide, or hafnium oxide disposed on at least a portion of the nanofibers.

Referring back to the step of contacting at least a portion of the nanofibers of a polyamic acid nanoweb with the coating solution comprising an organometallic compound to form a conformally-coated polyamic acid nanoweb, while not bound by any specific theory, it is believed that the coordinated metal alkoxide precursor will react with any surface-exposed amide or carboxylic acid functionality of the polyamic acid to generate metal amidate or carboxylate complexes, respectively, as shown below:

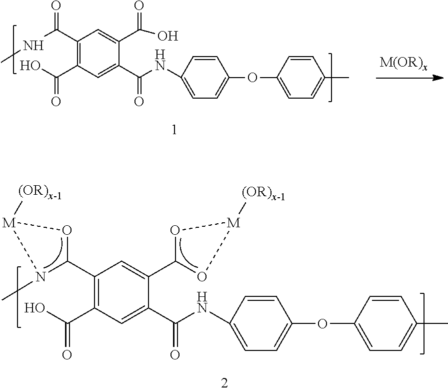

The process further comprises maintaining the precursor-coated polyamic acid nanoweb at a temperature in the range of room temperature to a first temperature until a desired degree of conversion to an oxide-coated polyamic acid nanoweb has achieved. As used herein, the first temperature is 1° C. below the temperature at which an infrared spectrum of the polyamic acid nanoweb yields a ratio of the absorbance of the imide C—N stretch at or near 1375 cm-1 to the absorbance of the aromatic C—H stretch at or near 1500 cm-1 is greater than 0.25, wherein the ratio 0.25 corresponds to a temperature where at least 50% of the polyamic acid nanoweb has been converted to polyimide nanoweb.

In an embodiment, the process also comprises maintaining the precursor-coated polyamic acid nanoweb at a temperature in the range of room temperature to 200° C., or 40-175° C., or 60-150° C. until a desired degree of conversion to an oxide-coated polyamic acid nanoweb has achieved. The desired degree of conversion of a precursor-coated polyamic acid nanoweb to an oxide-coated polyamic acid nanoweb can be 100%, or at least 90%, or at least 80%. The amount of degree of conversion and the temperature at which the conversion is carried out will determine the amount of time necessary for the conversion. In an embodiment, the amount of time is in the range of 1 s to 30 min, or 10 s to 10 min, or 30 s to 5 min. The completion of the conversion of a precursor-coated polyamic acid nanoweb to an oxide-coated polyamic acid nanoweb can be monitored by thermogravimetric analysis as the time at which the mass loss ceases at a given temperature. Exposure of the complex, 2 to water or to a temperature below the imidization temperature defined infra, of the polyamic acid (to avoid conversion of polyamic acid to polyimide) will convert the organometallic compound to metal oxide which is speculated to bound to the polymer surface as shown below:

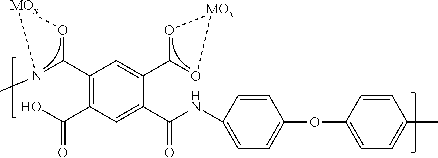

In an embodiment, the step of converting the precursor-coated polyamic acid nanoweb to an oxide-coated polyamic acid nanoweb comprises first drying in an inert environment such as, nitrogen or argon, at a temperature in the range of room temperature to 100° C. or 30-90° C., or 50-75° C. for an amount of time in the range of 1 s to 10 min or 10 s to 5 min, or 30 s to 2 min followed by heating in air at room temperature to 200° C., or 40-175° C., or 60-150° C. for an amount of time in the range of 1 s to 30 min, or 10 s to 10 min, or 30 s to 5 min (this heating step accomplishes the majority of precursor conversion to oxide, but some precursor may remain unconverted).

The process of conversion of the polyamic acid nanoweb to polyimide nanoweb comprises heating the oxide-coated polyamic acid nanoweb or the uncoated polyamic acid nanoweb to a temperature in the range of a second temperature and a third temperature for a period of time in the range of 5 s to 5 min, or from 5 s to 4 min, or from 5 s to 3 min, or from 5 s to 30 s. The second temperature is the imidization temperature of the polyamic acid. For the purposes of the present invention, the imidization temperature for a given polyamic acid is the temperature below 500° C. at which in thermogravimetric (TGA) analysis performed at a heating rate of 50° C./min, the % weight loss/° C. decreases to below 1.0, preferably below 0.5 with a precision of ±0.005% in weight % and ±0.05° C. The third temperature is the decomposition temperature of the polyimide formed from the given polyamic acid. Furthermore, for the purposes of the present invention, the decomposition temperature of the polyimide is the temperature above the imidization temperature at which in thermogravimetric (TGA), the % weight loss/° C. increases to above 1.0, preferably above 0.5 with a precision of ±0.005% in weight % and ±0.05° C.

In one method suitable for the practice of invention, the oxide-coated polyamic acid nanoweb is pre-heated at a temperature in the range of room temperature and the imidization temperature before the step of heating the oxide-coated polyamic acid nanoweb at a temperature in the range of the imidization temperature and the decomposition temperature. This additional step of pre-heating below the imidization temperature allows slow removal of the residual solvent present in the polyamic acid and prevents the possibility of flash fire due to sudden removal and high concentration of solvent vapor if heated at or above the imidization temperature.

The step of thermally converting the polyamic acid nanoweb to polyimide nanoweb can include any suitable technique, such as, heating in a convection oven, vacuum oven, infra-red oven in air or in inert atmosphere such as argon or nitrogen. A suitable oven can be set at a single temperature or can have multiple temperature zones, with each zone set at a different temperature. In an embodiment, the heating can be done step wise as done in a batch process. In another embodiment, the heating can be done in a continuous process, where the sample can experience a temperature gradient. In certain embodiments, the polyamic acid nanoweb is heated at a rate in the range of 60° C./minute to 250° C./second, or from 250° C./minute to 250° C./second.

In one embodiment, the oxide-coated polyamic acid nanoweb is heated in a multi-zone infra-red oven with each zone set to a different temperature. In an alternative embodiment, all the zones are set to the same temperature. In another embodiment the infrared oven further comprises an infra-red heater above and below a conveyor belt. In a further embodiment of the infrared oven suitable for use in the invention, each temperature zone is set to a temperature in the range of room temperature and a fourth temperature, the fourth temperature being 150° C. above the second temperature. It should be noted that the temperature of each zone in an infra-red oven is determined by the particular polyamic acid, time of exposure, fiber diameter, emitter to emitter distance, residual solvent content, purge air temperature and flow, fiber web basis weight (basis weight is the weight of the material in grams per square meter). For example, conventional annealing range is 400-500° C. for PMDA/ODA, but is around 200° C. for BPDA/RODA. Also, one can shorten the exposure time, but increase the temperature of the infra-red oven and vice versa. In one embodiment, the polyamic acid nanoweb is carried through the oven on a conveyor belt and goes though each zone for a total time in the range of 5 s to 5 min, set by the speed of the conveyor belt. In another embodiment, the polyamic acid nanoweb is not supported by a conveyor belt.

In an embodiment, the protective region comprising a coating on the fibers is a conformal coating or a non-conformal coating.

The coated polyimide webs can be used for a variety of applications, for example, separator for certain electrolytes in an electrochemical cell, as a capacitor and a lithium-ion battery. The disclosed coated polyimide web provides impedes electrochemical polyimide reduction as compared to an electrochemical cell which comprises an uncoated polyimide nanoweb.

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), or both A and B is true (or present).

As used herein, the phrase “one or more” is intended to cover a non-exclusive inclusion. For example, one or more of A, B, and C implies any one of the following: A alone, B alone, C alone, a combination of A and B, a combination of B and C, a combination of A and C, or a combination of A, B, and C.

Also, use of “a” or “an” are employed to describe elements and described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the disclosed compositions, suitable methods and materials are described below.

In the foregoing specification, the concepts have been disclosed with reference to specific embodiments. However, one of ordinary skill in the art appreciates that various modifications and changes can be made without departing from the scope of the invention as set forth in the claims below.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all embodiments.

It is to be appreciated that certain features are, for clarity, described herein in the context of separate embodiments, may also be provided in combination in a single embodiment. Conversely, various features that are, for brevity, described in the context of a single embodiment, may also be provided separately or in any sub-combination. Further, reference to values stated in ranges includes each and every value within that range.

The concepts disclosed herein will be further described in the following examples, which do not limit the scope of the invention described in the claims.

The examples cited here relate to polyimide nanowebs having a conformal coating of metal oxide or a polymer to be used as separators for electrochemical cells including capacitors and batteries. The discussion below describes how a polyimide nanoweb having a conformal coating of metal oxide or a polymer is formed and it's use in an electrochemical cell.

Unless specified otherwise, compositions are given as weight percentages.

### Test Methods

### Pore Size Measurement

Mean flow pore size was measured according to ASTM Designation E 1294-89, “Standard Test Method for Pore Size Characteristics of Membrane Filters Using Automated Liquid Porosimeter” incorporated herein by reference in its entirety. A capillary Flow Porometer CFP-2100AE (Porous Materials Inc. Ithaca, N.Y.) was used. Individual samples of 25 mm diameter were wetted with a low surface tension fluid (1,1,2,3,3,3-hexafluoropropene, or “Galwick,” having a surface tension of 16 dyne/cm) and placed in a holder, and a differential pressure of air was applied and the fluid removed from the sample. The differential pressure at which wet flow is equal to one-half the dry flow (flow without wetting solvent) was used to calculate the mean flow pore size using supplied software. The Bubble point pore size was determined by the first registered pore size for wet flow.

### Thickness

Thickness measurements were made as per ASTM D-3767, using an Electromatic Check Line thickness gauge model# MTG-D. The employed gauge pressure and foot diameter were 10 kPa and 16 mm respectively. This type of measurement refers to ASTM D-3767. Thickness values were averaged from three representative areas of the sample. Thickness is reported in micrometers (μm).

### Basis Weight

Basis Weight was determined according to ASTM D-3776 and reported in g/m2.

### Air Permeability

The air permeability was measured according to ASTM Designation D726-94. Individual samples were placed in the holder of Automatic Densometer model 4340 (Gurley Precision Instruments, Troy, N.Y.) and an air at a pressure of 0.304 (kPa) is forced through an area of 0.1 inch² or 0.645 cm² of the sample, recalculated by software to 1 inch² or 6.45 cm². The time in seconds required for 100 (cm³) of air to pass through the sample was recorded as the Gurley air permeability with the units of (s/100 cm³ or s/100 cc).

### Assembly of Lithium-Ion Coin Cells (CR2032)

Round-shape pieces (with a diameter of ¾ inch) were punched from each of the coated polyimide nanowebs of Examples 1-3 and dried overnight at 90° C. in a vacuum chamber. The thus dried specimens were incorporated into electrochemical coin cells.

Li-ion coin cells (CR2032) were assembled in an Ar glove box from dried components as follows. The anode comprised natural graphite coated on Cu and cathode comprised a layer of LiCoO₂ coated on Al foil, both obtained from Pred Materials International. The electrolyte comprised 1 Molar LiPF₆ in a 70:30 mixture of ethyl methyl carbonate and ethylene carbonate obtained from Ferro Corporation (Cleveland, Ohio).

### Polyimide Reduction Measurements:

Lithium coin cells were assembled with Example 1-3 and Comparative Example A using stainless steel cans obtained from Farasis (Hayward, Calif.). Glass paper was used to cover the cathode to prevent reoxidation of the reduced LiPI species, so that complete extent of PI reduction and reaction propagation through the separator would be observable. The coin cells were heated to 55° C., charged to 4.2 V and held at open circuit for 24 h, 48 h and 168 h, after which they were opened in the argon glove box. The separator was recovered, rinsed in propylene carbonate and THF to remove the electrolyte and allowed to dry. The extent of green color, indicative of LiPI was observed qualitatively. In addition, quantitative estimation of PI reduction on both sides was carried out via ATR-IR spectra using the following formula:

$${X}_{LIPI} = ( \frac{{Abs}_{1435 {cm}^{- 1}}}{{Abs}_{1115 {cm}^{- 1}}} ) \cdot 0.45$$

### Li-ICP Measurements:

After Polyimide reduction measurement, the separator was exhumed from the coin cell in an Argon dry box. The polyimide separator was rinsed with ethylene carbonate, and THF (distilled in benzophenone/Na) twice (in this sequence); and taken out of the Ar box. Measurement of the Li⁺ content for an individual separator by ICP-MS provided estimates of the net extent of reduction in equivalents Li⁺/polyimide repeat unit and was reported as the mole ratios of reduced polyimide amount

### Mechanical Properties

Young's modulus, tensile stress at break and tensile strain were measured in accordance with ASTM: D828-97 using Instron equipment (model INSTU-MET 1123) with a 50 lb load cell (SN:749C) and smooth grips fitted with rubber faces. The grips were spaced 3 inches apart. The instrument was calibrated with a 5 lb weight and tested against a 1 lb standard before each measurement. A 6″×0.5″ sample size was employed and sample length was aligned with either the manufactured machine direction or the cross direction, depending on the desired measurement. Each sample was tested at rate of elongation of 10 mm min⁻¹ and the force and elongation data was collected at a 50 Hz rate.

### EXAMPLES

### Preparation of Polyamic Acid Solution

4,4 oxydianiline (ODA) (Wakayama Seika) (32.19 kg) was added to 215.51 kg of dimethylformamide (DMF) (DuPont) in a 100 gallon stainless steel reactor, followed by addition of 33.99 kg of pyromellitic dianhydride (PMDA) (DuPont Mitsubishi Gas Ltd.) and then 1.43 kg of phthalic anhydride (Aldrich Chemical) to the reactor. The reactants were stirred at room temperature for 30 hours to form polyamic acid (PAA) having a room temperature solution viscosity of 5.8 Pa·s.

### Preparation of Polyamic Acid Nanowebs

The PAA solution (50 kg) prepared supra was electroblown into a fibrous web according to the process described in U.S. Published Patent Application No. 2005/0067732, hereby incorporated herein in its entirety by reference. The resulting nanoweb was about 120 microns thick with a porosity of about 85% and with a mean average fiber diameter of 500 nm. The nanoweb was then manually unwound and cut with a manual rolling blade cutter into hand sheets 30.5 cm (12″) long and 25.4 cm (10″) wide.

### Preparation of Imidized, Uncalendered Nanowebs

The nanoweb layers prepared supra were heat treated according to the procedure described in copending U.S. patent application Ser. No. 12/899,770, hereby incorporated herein in its entirety by reference.

### Comparative Example A

### Preparation of Imidized, Calendered Nanowebs

The heat treated nanoweb layers prepared supra were calendered through a steel/cotton nip at 140 pounds per linear inch and 160° C.

### Example 1

### Preparation of Melamine Formaldehyde Coated Nanowebs Using Dip Coating

A sample (20.3 cm×10.2 cm or 8″×4″) of imidized, uncalendered polyimide nanoweb was dipped in a 2.5% Cymel 385 aqueous Melamine Formaldehyde resin solution (from Cytec industries) containing 0.15 wt. % CYCAT 4045 catalyst (from Cytec Industries). The coated sample was dried at room temperature and calendered between a hard steel roll and a cotton covered roll at 90° C. and 8300 pounds per linear inch (or 1,454,751 N/m) on a BF Perkins calender. After calendering, the hand sheets were baked at 200° C. for 10 minutes in a convection oven.

### Example 2

### Preparation of Melamine Formaldehyde Coated Nanowebs Using Gravure Coating

A sample roll of 3.75 inch (or 9.72 cm) wide, imidized, uncalendered, polyimide nanoweb, was coated with a 5 wt. % water/methanol (3:1) solution of Cymel 385 Melamine Formaldehyde resin solution containing 0.15 wt % CYCAT 6395 catalyst in using a Yasui Seiki Microgravure™ Lab-o-coater. The gravure roll speed, dryer temperature and line speed were set at 19 rpm, 70° C. and 0.14 m/min, respectively. The coated sample was dried at room temperature and calendered between a hard steel roll and a cotton covered roll at 90° C. and 8854 pounds per linear inch (or 1,550,484 N/m) on a BF Perkins calendar. After calendering, the hand sheets were baked at 150° C. for 10 minutes in a convection oven.

### Example 3

### Preparation of Urea Formaldehyde Coated Nanowebs Using Dip Coating

A sample (20.3 cm×9.52 cm or 8″×3.75″) of imidized, uncalendered, polyimide nanoweb was dipped in a 3 wt. % Plastopal BTW aqueous Urea Formaldehyde resin solution (from BASF) containing 0.15 wt. % CYCAT 6395 catalyst (from Cytec Industries). The coated sample was dried at room temperature and calendered between a hard steel roll and a cotton covered roll at 90° C. and 8854 pounds per linear inch (or 1,550,484 N/m) on a BF Perkins calendar. After calendering, the hand sheets were baked at 150° C. for 10 minutes in a convection oven.

### Example 4

### Preparation of Low Density Polyethylene Coated Nanowebs Using Dip Coating

A 3.75 inches (or 9.52 cm) wide sample roll of imidized, uncalendered of polyimide nanoweb was dipped in a 1 wt. % solids Low Density Polyethylene (LDPE 1640, DuPont) solution in decahydronapthalene at 75° C. The coated sample was dried at 100° C. in a convection oven and calendered between two hard steel rolls at 40° C. and 8300 pounds per linear inch (or 1,454,751 N/m) on a BF Perkins calendar.

### Example 5

### Preparation of Polypropylene Coated Nanowebs Using Dip Coating

A sample (20.3 cm×10.2 cm or 8″×4″) of imidized, uncalendered polyimide nanoweb was dipped in a 2 wt. % polypropylene (Equistar RP232M, Lyondell-Basel) solution in decahydronapthalene at 80° C. The coated sample was dried at 100° C. in a convection oven and calendered between two hard steel rolls at room temperature and 8300 pounds per linear inch (or 1,454,751 N/m) on a BF Perkins calendar.

### Example 6

### Preparation of Sodium Carboxymethyl Cellulose Coated Nanowebs Using Spray Coating

A sample (20.3 cm×10.2 cm or 8″×4″) of imidized, uncalendered polyimide nanoweb was dipped into 100 mL of 0.5 wt. % sodium carboxymethyl cellulose (Sigma Aldrich, M_{w} 250,000 g/mol) aqueous solution. The coated sample was dried in a convection oven at 120° C. for 30 min and calendered between two hard steel rolls at room temperature and 8300 pounds per linear inch (or 1,454,751 N/m) on a BF Perkins calendar.

### Example 7

### Preparation of Poly(Dimethylsiloxane) Coated Nanowebs Using Dip Coating

A sample (20.3 cm×10.2 cm or 8″×4″) of imidized, uncalendered polyimide nanoweb was dipped in 11 wt. % mixture of siloxane oligomer base and crosslinker (Sylgard® 184, Dow Corning, 10:1 oligomer: crosslinker ratio by weight) in toluene. The coated sample was cured at 70° C. in a convection oven for 2 h and calendered between two hard steel rolls at room temperature and 8300 pounds per linear inch (or 1,454,751 N/m) on a BF Perkins calendar.

### Example 8

### Preparation of Poly(Acrylonitrile) Coated Nanowebs Using Dip Coating

A sample (20.3 cm×10.2 cm or 8″×4″) of imidized, uncalendered polyimide nanoweb was dipped in a 2 wt. % poly(acrylonitrile) (Sigma Aldrich, Mw 150,000 g/mol) dimethylformamide solution at 80° C. The coated sample was dried at 100° C. in a convection oven for 2 h and calendered between two hard steel rolls at room temperature and 8300 pounds per linear inch (or 1,454,751 N/m) on a BF Perkins calendar.

### Example 9

### Preparation of Silica Nanoparticle Coated Nanowebs Using Dip Coating

A sample (20.3 cm×9.52 cm or 8″×3.75″) of polyamic acid nanoweb was dipped into a 1.5 wt. % dispersion of silica nanoparticles and poly(ethylene oxide) (M_{w} 100 kD, Sigma Aldrich) in 2:1 ratio (by wt.) in Chloroform. The coated sample was dried at room temperature and imidized in an air convection oven at 350° C. for 2 minutes, after which it was calendered between two hard steel rolls at room temperature and 2075 pounds per linear inch (or 363687.75 N/m) on a BF Perkins calendar.

### Example 10

### Preparation of Silica Nanoparticle/Silsesquioxane Binder Coated Nanowebs Using Drawdown Coating

A sample (20.3 cm×9.52 cm or 8″×3.75″) of imidized, calendered polyimide nanoweb was coated with a 12 wt. % silica nanoparticles (Ludox® TMA, 20 nm diameter, Sigma Aldrich) and silsesquioxane binder (Gelest WSA 7011, Gelest Inc) in water/isopropanol mixture. The particle/binder ratio is 2:1 by weight and the solvent ratio is 10:90 by weight for water to isopropanol. The coated sample was dried at room temperature.

### Example 11

### Preparation of Acrylate Coated Nanowebs Using Atmospheric Pressure Plasma Liquid Deposition (APPLD)

A sample (20.3 cm×20.32 cm or 8″×8″) of imidized, calendered polyimide nanoweb was coated via the atmospheric pressure plasma deposition process disclosed in WO2001/59809, WO2002/28548, WO2005/110626 and US2005/0178330. The following process conditions were used: Monomer feed rate: 500 mmL/min; web speed: 2.5 m/min; plasma power: 5 kW; web tension: 10N; Helium gas consumption: 30 L/min. The acrylates employed were: Stearyl acrylate (SR257C, Sartomer Company, PA), propoxylated neopentyl glycol diacrylate (SR9003), tricyclodecane dimethanol diacrylate (SR833S, Sartomer Company, PA), isobornyl acrylate (SR506D, Sartomer Company, PA), ethoxylated trimethylolpropane acrylate (SR9035, Sartomer Company, PA) and Lauryl acrylate (SR335, Sartomer Company, PA). The combination of materials employed for each sample is outlined in Table 1.

TABLE 1
Compositions of APPLD Coatings

| Ex- | | | | | | | |
|---|---|---|---|---|---|---|---|
| am- | | | | | | | |
| ple | SR257C | SR335 | SR9003 | SR833S | SR506D | SR9035 | Total |
| 11a | 43 | 42 | | | | 15 | 100 |
| 11b | | | 85 | | | 15 | 100 |
| 11c | | 41 | | 49 | | 10 | 100 |
| 11d | | | | | 85 | 15 | 100 |

### Example 12

### Preparation of Silsesquioxane Copolymer-Coated Polyimide Nanowebs Using Dip Coating

A sample (5″×8″) of imidized, uncalendered polyimide nanoweb was dipped in 2 wt. % silsesquioxane copolymer (Gelest-WSA-7011, FIG. 1) aqueous solution with 1% of isopropanol as co-solvent. It was dried in ventilation hood for 5 min and then at 100° C. for 2 min. The coated sample achieved a loading of 17% by weight. The coated material was then calendered at 1500 psi, room temperature, between stainless steel calendering rolls.

### Example 13

### Preparation of Silica Microspheres-Coated Polyimide Nanowebs Using Silsesquioxane Copolymer Binder

Silica microspheres (Fiber Optic Center Inc.) with average diameter of 4 μm were dispersed in 2-propanol (Aldrich) to make 2% wt dispersion and it was placed in a sonication bath for 2 h. The silica microspheres dispersion was then mixed with 1% silsesquioxane copolymer aqueous solution (Evonik Hydrosil 2627) in the ratio of 2:1 by weight. The mixture was charged in to a glass vial with a spray head mounted through the cap. A sample (8″×10″) of calendered imidized HMT was placed on top of a paper towel (Sontara®, DuPont). The silica microspheres/silsesquioxane copolymer mixture was sprayed over the imidized, calendered nanoweb five times and then the coated sample was dried in place.

### Comparative Example B

### Imidized, Calendered Polyimide Nanowebs

The heat treated nanoweb layers prepared supra (according to the procedure described in copending U.S. patent application Ser. No. 12/899,770, hereby incorporated herein in its entirety by reference) were calendered at 150° C. between a hard steel roll and a cotton covered roll at 25001.6 kg/m (1400 pounds per linear inch).

### Example 14

### Preparation of Silica Nanoparticle Coated Polyimide Nanowebs Using Silsesquioxane Copolymer Binder Via Slot Die Coating

A dispersion of silsesquioxane binder and Silica nanoparticles (Aerodisp® W7215S, with a hydrodynamic radius of 200 nm) was prepared using following procedure: 30 g of the silsesquioxane binder (Gelest WSA 7011) was added into 6 g of phosphoric acid (Sigma Aldrich, 85% in water). After vigorous agitation to obtain a clear dispersion, 360 g of Aerodisp® W7215S was added, followed by 454 g of DI water and 150 g of n-propanol. The dispersion was agitated via magnetic stirring to ensure uniform mixing. This formulation was coated onto an imidized, calendered nanoweb prepared supra via a two-step slot die coating process. The first step involved depositing a 10 wt % Gelest WSA 7011 solution (aq., containing 3 wt. % n-propanol), following which a layer of the aforementioned nanoparticle formulation was applied over the top of the coated polyimide nanoweb through a second pass using the slot-die coater. A 3 mil PET carrier sheet, a line speed of 10 feet/min and a pump rate of 6 mL/min were used for the first step coating and a line speed of 5 feet/min and a pump rate of 5 mL/min were used for the second step coating. This sample exhibited a mean flow pore diameter of 0.08 μm and bubble point diameter of 0.27 μm.

### Example 15

### Investigation of Robustness of Silica Nanoparticles Coated Polyimide Nanowebs Using Silsesquioxane Copolymer Binder Via Slot Die Coating

The coating robustness of Example 14 was tested as follows. The substrate was rubbed against a Mylar film (coating side facing Mylar) in circular motion 20 times to simulate rubbing, handling, folding and cracking action. After this, the substrate was severely crumpled along with the Mylar® sheet. The substrate was then imaged via SEM to assess extent of transfer/shedding and other characteristics such as permeability, pore size and basis weight were also measured. While there was some amount of coating transfer seen on Mylar, the basis weight, pore size and air permeability changes were insignificant (Table 2).

TABLE 2
Physical Characteristics of Silica Nanoparticle/Silsesquioxane
Coated Nanowebs Before and After Robustness Testing.

| | MFP | BP | Gurley | Thickness | BW |
|---|---|---|---|---|---|
| Example | (um) | (um) | (s) | (um) | (gsm) |
| 14 as coated | 0.10 | 0.36 | 65.5 | 20 | 18.9 |
| 14 after testing | 0.10 | 0.43 | 62.9 | 22 | 19.67 |
| for robustness | | | | | |

### Examples 16

### Preparation of ZrOₓ-Coated Polyimide Nanowebs

Two samples (10.2 cm×10.2 cm or 4″×4″) of PAA nanoweb prepared supra were calendered at room temperature between a hard steel roll and a cotton covered roll at 32144.9 kg/m (1800 pounds per linear inch) on a BF Perkins calendar and were dried at 75° C. in a N₂-purged vacuum oven for 30 minutes. The samples were imidized in an air convection oven at 350° C. for 2 minutes. Sample 16a was subsequently dipped at room temperature into 0.1% (v/v) solution of zirconium tetra(tert-butoxide) in dry tetrahydrofuran (THF) for 5 s and rinsed in clean THF for 30 s. Sample 16b was dipped at room temperature into 1% (v/v) solution of zirconium tetra(tert-butoxide) in dry tetrahydrofuran (THF) for 5 s. The samples were dried in a nitrogen glove box for 2 min at 100° C., and subsequently annealed in an air convection oven for 2 min at 450° C. ICP-MS of the samples indicated 0.19% Zr by weight

### Example 17

### Preparation of TaOₓ-Coated Polyimide Nanowebs

A sample (10.2 cm×10.2 cm or 4″×4″) of Polyamic acid nanoweb was dried at 75° C. in a N₂-purged vacuum oven for 30 min. It was subsequently dipped into a 1.5% (v/v) solution of tantalum penta(ethoxide) in dry THF for 5 s. It was next dried under nitrogen for 2 min at 100° C., and dried in an air convection oven for 2 min at 200° C. The sample was next calendered at room temperature between a hard steel roll and a cotton-covered roll at 9,307,922.35 Pascal (1350 psi), and was subsequently imidized and annealed in an air convection oven for 2 min each at 350° C. and 450° C., respectively. ICP-MS of the sample indicated 9.32% Ta by weight.

### Example 18

### Preparation of Polyisobutylene-Coated Polyimide Nanoweb

A sample (10.2 cm×10.2 cm or 4″×4″) of Polyamic acidAA nanoweb prepared supra was calendered at room temperature between a hard steel roll and a cotton-covered roll at 32144.9 kg/m (1800 pounds per linear inch) on a BF Perkins calendar and was dried at 75° C. in a N₂-purged vacuum oven for 30 minutes. The sample was imidized in an air convection oven at 350° C. for 2 minutes. The imidized sample was subsequently dipped in a 1% by weight solution of polyisobutylene (Cat #181455, Sigma-Aldrich, St. Louis, Mo.) in toluene at room temperature. The solution was prepared by dissolving the polymer resin in toluene at room temperature overnight with stirring.

### Example 19

### Preparation of (3-Aminopropyl)Trimethoxysilane Coated Polyimide Nanowebs Using Dip Coating

A sample (13 cm×20 cm or 5″×8″) of calendered imidized polyimide nanoweb was dipped in 5 wt. % (3-aminopropyl) trimethoxysilane (Aldrich) in ethanol. The coated sample was dried in air for 10 min and then dried at 100° C. for 5 min.

### Example 20

### Preparation of (3-Aminopropyl)Trimethoxysilane and Octadecyltrimethoxysilane Coated Polyimide Nanowebs Using Dip Coating

A sample (13 cm×20×m or 5″×8″) of imidized uncalendered polyimide nanoweb was dipped in 4 wt. % (3-aminopropyl) trimethoxysilane (Aldrich) in isopropanol (Aldrich), dried and then dip-coated in 1% octadecyltrimethoxy silane (Aldrich) in toluene. After drying, the sample was calendered at 8300 pounds per linear inch (or 1,454,751 N/m) at room temperature.

The polyimide reduction protection efficiency of these coatings is elucidated in table 3.

TABLE 3
Properties and Protection Efficiency
of Coated Polyimide Nanowebs

| | | | | | | 168 Hour | |
|---|---|---|---|---|---|---|---|
| | | | | | | PI | |
| | | | | | 168 Hour | Reduction | |
| | | | | | PI | Mol | |
| | | | | | Reduction | Fraction | |
| | | | | | Mole | for | |
| | Loading | Thickness | | B.W. | Fraction- | Control- | Protection |
| Example # | (%) | (μm) | Gurley (s) | (gsm) | Cathode | Cathode | Efficiency |
| 1 | 31 | 32.4 | 0.9 | 15.29 | 0 | 0.37 | 100% |
| 2 | 32.88 | 32.7 | 2.1 | 18.25 | 0 | 0.37 | 100% |
| 3 | 39.33 | 33.3 | 0.9 | 17.89 | 0.09 | 0.37 | 76% |
| 4 | 15.2 | 24 | 1.9 | 17.69 | 0.15 | 0.37 | 59% |
| 5 | 30.1 | 40.5 | 33.5 | 23.46 | 0 | 0.37 | 100% |
| 6 | 43.12 | 45.8 | 15.6 | 26.65 | 0 | 0.37 | 100% |
| 7 | 44.44 | 63.8 | 2.9 | 45.31 | 0 | 0.37 | 100% |
| 8 | 30.56 | 38.2 | 15.9 | 26.83 | 0 | 0.37 | 100% |
| 9 | 44.25 | 40.8 | 202 | 32.55 | 0.14 | 0.37 | 62% |
| 10 | 11.03 | 23 | 17 | 20.16 | 0 | 0.37 | 100% |
| 11a | 13 | 40 | 0.4 | 23.78 | 0 | 0.37 | 100% |
| 11b | 13 | 40 | 0.4 | 22.76 | 0 | 0.37 | 100% |
| 11c | 13 | 40 | 0.38 | 22.97 | 0 | 0.37 | 100% |
| 11d | 13 | 40 | 0.44 | 23.08 | 0.1 | 0.37 | 73% |
| 12 | 17 | 26 | 10.8 | 17.55 | 0 | 0.37 | 100% |
| 13 | 32.3 | 30 | 7.8 | 20.1 | 0.06 | 0.39 | 85% |
| 14 | 1.4 | 20 | 65.7 | 17.94 | 0.05 | 1.07 | 95% |
| 16 | 0.6 | 29 | <1 s | 18.1 | 0 | 0.39 | 100% |
| 17 | 9 | 29 | <1 s | 19.62 | 0 | 0.39 | 100% |
| 18 | 20 | 29 | <1 s | 18.2 | 0 | 0.39 | 100% |
| 19 | 7.4 | 29 | 58 | 15 | 0.06 | 0.39 | 85% |
| 20 | 30.7 | 39 | 0.5 | 15 | 0 | 0.39 | 100% |
| Comparative | 0 | 17 | 3.5 | 13.6 | 0.37 | 0.37 | 0% |
| Example A | | | | | | | |
| Comparative | 0 | 20 | 19.4 | 16.98 | 1.07 | 1.07 | 0% |
| Example B | | | | | | | |

### Examples 22A and 22B

### Polyimide Nanowebs Containing Electrolyte Additives

A sample of polyimide nanoweb was chemically reduced by soaking in 0.5 M Li(Naphthalide) solution for 1 min. Then it was treated with 1 wt. % 1,3-propane sultone in dry THF for 1 h. The sulfopropanated sample (Example 22A) was rinsed in dry THF, dried and assembled into coin cells for aging at 55° C. Example 22B was prepared by adding 5 wt. % 1,3-propane sultone to electrolyte during coin cell fabrication where a polyimide nanoweb was used as a separator. The polyimide reduction protection efficiency of these additives is elucidated in table 4.

TABLE 4
Protection Efficiency of Polyimide Nanowebs
Containing Electrolyte Additives

| | | 8 Day PI | |
|---|---|---|---|
| | 8 Day PI | Reduction | |
| | Reduction | Mole | |
| | Mole | Fraction for | |
| | Fraction- | Control- | Protection |
| Example | Cathode | Cathode | Efficiency |
| 20A | 0 | 0.37 | 100.0% |
| 20B | 0.11 | 0.37 | 70.3% |

What is claimed is:

1. A separator for an electrochemical cell, the separator comprising:
(a) a web comprising fibers of a polyimide; and
(b) a protective region wherein the protective region impedes electrochemical polyimide reduction.

2. The separator of claim 1, wherein the web is a nanoweb and the fibers are nanofibers wherein the nanofibers are characterized by a number average diameter in the range of one of: less than about 1000 nm, from about 50 to about 800 nm, or from about 100 to about 400 nm.

3. The separator of claim 1, wherein the polyimide is fully-aromatic.

4. The separator of claim 3, wherein the fully aromatic polyimide comprises:
(a) at least one aromatic dianhydride as a monomer unit selected from the group consisting of pyromellitic dianhydride (PMDA), biphenyltetracarboxylic dianhydride (BPDA), and 3,3′,4,4′-benzophenone tetracarboxylic dianhydride (BTDA), and mixtures thereof; and
(b) at least one diamine as a monomeric unit selected from the group consisting of oxydianiline (ODA), 1,3-bis(4-aminophenoxy)benzene (RODA), 1,4-phenelenediamine (PDA), and mixtures thereof.

5. The separator of claim 3, wherein the fully-aromatic polyimide has the following formula:

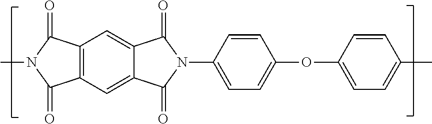

6. The separator of claim 1, wherein the protective region comprises a coating on the fibers comprising:
(a) particles of oxides of silicon, aluminum, calcium, or mixtures thereof, ranging from about 1 to about 20,000 nm, from about 1 to about 10,000 nm, or from about 1 to about 4,000 nm in diameter, and, optionally, a binder;
(b) oxides of zirconium, tantalum, silicon, hafnium, or mixtures thereof;
(c) silanes;
(d) silsesquioxanes;
(e) organic polymers characterized with a Hansen solubility parameter (δp) of at most about 19.2 MPa^{1/2} or at least about 23.2 MPa^{1/2}; or
(f) mixtures thereof.

7. The separator of claim 6, wherein the silane is selected from the group consisting of (3-aminopropyl) trimethyoxy silane and octadecyltrimethoxy silane.

8. The separator of claim 6, wherein the organic polymers are selected from the group consisting of polyethylene, polypropylene, polyisobutylene, poly(dimethylsiloxane), polyvinylpyrrolidone, sodiumcarboxymethyl cellulose, melamine formaldehyde resins, urea formaldehyde resins, and polyacrylonitrile.

9. The separator of claim 6, wherein the coating is a conformal coating or a non-conformal coating.

10. The separator of claim 6, wherein the coating has an average thickness in the range of one of: from about 0.1 to about 5000 nm, from about 1 to about 175 nm, or from about 2 to about 100 nm.

11. The separator of claim 1, wherein the protective region impedes electrochemical polyimide reduction resulting in an efficiency of protection for each electrode from one of: at least about 10%, at least about 20%, or at least about 30%.

12. The separator of claim 1, wherein the electrochemical cell is a lithium-ion battery or a lithium-ion capacitor.

13. A multi-layer article for an electrochemical cell, the multi-layer article comprising:
(a) a first electrode;
(b) a second electrode; and
(c) a separator disposed between and in contact with the first electrode and the second electrode, the separator comprising:
(i) a web comprising fibers of a polyimide; and
(ii) a protective region disposed between the web and at least one electrode wherein the protective region impedes electrochemical polyimide reduction.

14. An electrochemical cell comprising:
(a) an electrolyte;
(b) a multi-layer article, the multi-layer article comprising a first electrode, a second electrode in ionically conductive contact with the first electrode, and a separator disposed between and in contact with the first electrode and the second electrode, the separator comprising:
(i) a web comprising fibers of a polyimide; and
(ii) a protective region disposed between the web and at least one electrode wherein the protective region impedes electrochemical polyimide reduction;
(c) a first current collector in electrically conductive contact with the first electrode; and
(d) a second current collector in electrically conductive contact with the second electrode.
